(19) United States
(12) Patent Application Publication
(10) Pub. No.: US 2014/0305787 A1
(43) Pub. Date: Oct. 16, 2014

(54) PORTABLE SOLAR POWERED POTABLE WATER GENERATION SYSTEM

(71) Applicant: Hoa Ngoc Nguyen, Hollywood, FL (US)

(72) Inventor: Hoa Ngoc Nguyen, Hollywood, FL (US)

(21) Appl. No.: 14/253,860

(22) Filed: Apr. 15, 2014

Related U.S. Application Data
(60) Provisional application No. 61/812,001, filed on Apr. 15, 2013.

(51) Int. Cl. B01D 5/00; C02F 1/00

(52) U.S. Cl. CPC B01D 5/00; C02F 1/00
USPC 202/185.1

(57) ABSTRACT

A portable solar powered potable water generation system may include a dehumidifier, a at least one solar panel and an AC/DC converter. The at least one solar panel may be mounted onto the dehumidifier. The AC/DC converter may also be attached to the dehumidifier to power it with the at least one solar panel. In certain embodiments, an electrical wire may connect the at least one solar panel to the dehumidifier. A control panel may be located on the dehumidifier.

### CROSS-REFERENCE TO RELATED APPLICATION

This application claims the benefit of U.S. provisional application number 61/812,001, filed Apr. 15, 2013, the contents of which are herein incorporated by reference.

### BACKGROUND OF THE INVENTION

The present invention relates to generating potable water and, more particularly, to portable solar powered potable water generation.

Clean drinkable water is always needed in any situation that a person may find themselves. In extreme situations such as boat emergencies, adventure trips, or even being in third world countries, it may be hard to find access to potable water. In situations like these, one may find limited access to standard electrical power sources and water. Traditional safe and drinkable water sources, such as wells and tap water or bottled water, are also hard to locate in these situations. Transportation of water may be necessary but the distance may be too far or impractical in between these sources for the needs of an individual. However, in these situations there may be plenty of sunlight and humidity available.

As can be seen, there is a need for a potable water generation system that is portable and that uses solar energy and humidity which may be readily available.

### SUMMARY OF THE INVENTION

In one aspect of the present invention, a portable solar powered potable water generation system comprises: a dehumidifier; and at least one solar panel, wherein the at least one solar panel connects to the dehumidifier.

In another aspect of the present invention, a portable solar powered potable water generation system comprises: a dehumidifier having a control panel and a water condensation collection compartment; at least one solar panel connected to the dehumidifier; an electrical wire attached to the dehumidifier and the at least one solar panel; and a floating platform attached to the dehumidifier.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a portable solar powered potable water generation system that may include a dehumidifier, a at least one solar panel and an AC/DC converter. The at least one solar panel may be mounted onto the dehumidifier. The AC/DC converter may also be attached to the dehumidifier to power it with the at least one solar panel. In certain embodiments, an electrical wire may connect the at least one solar panel to the dehumidifier. A control panel may be located on the dehumidifier.

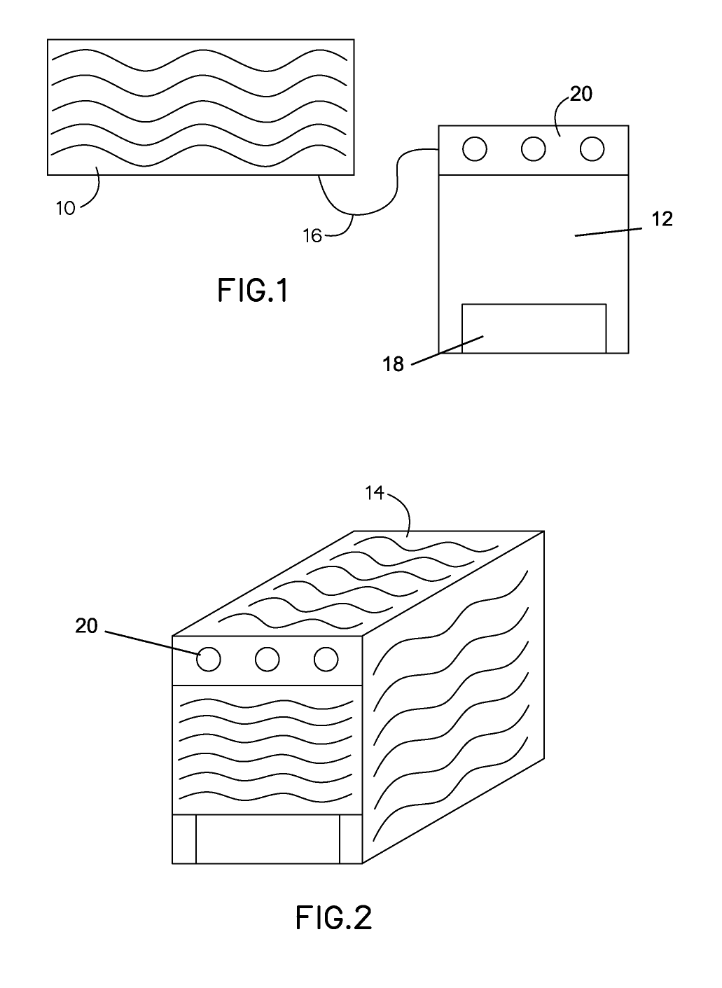

As is illustrated in FIGS. 1 and 2, a portable solar powered potable water generation system may include a dehumidifier 12. A control panel 20 may be located on the dehumidifier 12. At least one solar panel 10 may be connected to the dehumidifier 12. In certain embodiments, an electrical wire 16 may connect the at least one solar panel 10 to the dehumidifier 12. The electrical wire 16 may be an AC/DC converter. An alternate embodiment 14 may have the at least one solar panel 10 directly connected to the dehumidifier 12. The dehumidifier 12 may have a water condensation collection compartment 18.

In certain embodiments, the system may include a plug connected to a standard electrical outlet to produce potable water when there is no sunlight but electricity is available. In other embodiments, the solar panels may be located elsewhere and connected to the dehumidifier to produce water.

The present invention, by combining solar panels and producing electricity, may power a dehumidifier 12 that may have the capability of producing potable water anywhere that has sunlight and humidity. The system may be portable so that it may be taken anywhere.

A method of using the device may include the following. Solar panels 10 may be combined to produce electricity and using that electricity to power a dehumidifier 12 to make water. The solar panels 10 may be mounted onto the dehumidifier 12. An AC/DC converter may be attached to the solar panels 10 and may connect to the dehumidifier 12. In another embodiment, the solar panels 10 may be mounted to another object such as a boat, house or building. The solar panels 10 may be used to power the dehumidifier 12 which produces potable water.

In certain embodiments, a rechargeable battery with a USB port may be connected to the system. The battery may allow for the charging of such objects as a cell phone, small light, fire maker or GPS tracking device for location rescue.

In situations where the system may be used on a boat, in certain embodiments, a foam floating platform may be attached to the system to allow the system to float in case of a shipwreck. With plenty of sun light and humidity around them, a survivor may then have access to potable water until a rescue is possible. The system may be water tight to protect the electrical components of the system.

It should be understood, of course, that the foregoing relates to exemplary embodiments of the invention and that modifications may be made without departing from the spirit and scope of the invention as set forth in the following claims.

What is claimed is:

1. A portable solar powered potable water generation system comprising:
a dehumidifier; and
at least one solar panel, wherein the at least one solar panel connects to the dehumidifier.

2. The system of claim 1, further comprising an electrical wire attached to the dehumidifier and the at least one solar panel.

3. The system of claim 2, wherein the electrical wire is an AC/DC converter, wherein the AC/DC converter is attached to the dehumidifier and the at least one solar panel to form the portable solar powered potable water generation system.

4. The system of claim 1, further comprising a floating platform attached to the dehumidifier.

5. The system of claim 1, wherein the at least one solar panel mounts onto the dehumidifier.

6. The system of claim 1, wherein the dehumidifier has a control panel.

7. The system of claim 1, wherein the dehumidifier has a water condensation collection compartment.

8. The system of claim 6, further comprising a rechargeable battery attached to the control panel of the humidifier.

9. A portable solar powered potable water generation system comprising:
a dehumidifier having a control panel and a water condensation collection compartment;
at least one solar panel connected to the dehumidifier;
an electrical wire attached to the dehumidifier and the at least one solar panel; and
a floating platform attached to the dehumidifier.

10. The system of claim 9, further comprising a rechargeable battery attached to the control panel of the humidifier.
